(19) United States
(12) Patent Application Publication
(10) Pub. No.: US 2015/0093089 A1
(43) Pub. Date: Apr. 2, 2015

(54) Swing Out Optical Fiber Tray

(71) Applicant: Opterna Technology Limited, Limerick (IE)

(72) Inventors: Icy Kollielil VARGHESE, Kerala (IN); Subin Panakkal Sadasivan, Kerala (IN); Stefan Ivanov Donchev, Milton Keynes (GB)

(21) Appl. No.: 14/044,343

(22) Filed: Oct. 2, 2013

(51) Int. Cl. G02B 6/44

(52) U.S. Cl. CPC G02B 6/4471
USPC 385/135

(57) ABSTRACT

This disclosure is directed to a fiber optic tray assembly. The tray assembly includes a tray having a base portion configured to hold a fiber optic interconnect or splice. An adapter clamp is configured to be mounted to the tray to secure one or more fiber optic adapters to the tray at an angle greater then 0° and less than 90° relative to and substantially parallel to the base portion. A fiber manager is configured to be mounted to one side portion of the tray to secure one or more fiber optic cable leads exiting the tray toward the one side portion of the tray. The tray is approximately one half the height of a standard tray that holds fiber optic cables.

### BACKGROUND

1. Field of the Disclosure

This disclosure relate to optical fibers and more particularly to optical fiber trays.

2. Background

Fiber optic patching systems have become prevalent in the structured cabling market. In central offices, data centers and other wired buildings, fiber optic patch panels have become the media of choice to route connections between switches, servers, storage devices and general office areas. By “patching,” or temporarily creating a connection between physically mated connectors, it is possible to reconfigure network connections from a central location.

In order to reduce the effective area that a patching system utilizes in a facility, suppliers of fiber optic cables and interface apparatus have taken steps to reduce the size of the fiber optic connector. In the context of fiber optic patches, the terms “adapter” and “coupler” are interchangeable. Both terms refer to a device that creates a connection between two fiber optic ferrules, each containing a light carrying fiber medium. An adapter typically contains a ceramic or phosphorous bronze alignment sleeve and one Of more features that provide for latching a connector into the adapter. An MT-RJ adapter, however, does not include an alignment sleeve because the fibers are aligned by precision pins and holes on the mating connector ferrules.

Separately, suppliers of fiber optic connectivity hardware provide modular cassette patching products to the premise industry. These cassette systems allow the user to create a passive network link with, minimal experience in fiber optics. A user can install the cassette into a vertical rack cabinet, connect a backbone cable terminated with an MPO (Multi-Fiber Push On) connector, for example, to the rear of the cassette, connect a patch cord to the front of the cassette and then on to an optical transceiver. The same is repeated at the other end of the backbone cable, thereby creating an optical data link.

Conventional vertical stacking techniques allow for the user to insert and remove patch cords from the patch panel as well as manage the fiber in vertical cable managers. Typically, modular cassettes or trays are designed to slide in and out of a rack through the front of the assembly. The trays are designed only for front entry of optical fiber cables. This limits the configurations that can be employed when designing an optical fiber cabling system in a building.

These and other disadvantages and/or limitations are addressed and/or overcome by the assemblies and methods of the present disclosure.

### SUMMARY

This disclosure is directed to a fiber optic tray assembly. The tray assembly includes a tray having a base portion configured to hold a fiber optic interconnect or splice. An adapter clamp is configured to be mounted to the tray to secure one or more fiber optic adapters to the tray at an angle greater then 0° and less than 90° relative to and substantially parallel to the base portion. A fiber manager is configured to be mounted to one side portion of the tray to secure one or more fiber optic cable leads exiting the tray toward the one side portion of the tray. The tray is approximately one half the height of a standard tray that holds fiber optic cables.

### BRIEF DESCRIPTION OF THE DRAWING

The accompanying drawings, which are incorporated herein and form a part of the specification, illustrate the present disclosure and, together with the description, further serve to explain the principles of the disclosure and to enable a person skilled in the pertinent art to make and use the disclosure. Generally, the drawing in which an element first appears is typically indicated by the leftmost digit(s) in the corresponding reference number.

FIG. 1 is a perspective view of a half U tray assembly according to an exemplary embodiment of this disclosure.

FIG. 2 is a top plan view of the tray assembly showing an example of a cable routing.

FIG. 3 is a detail of the adapter clamp snap fit and the fiber manager hinged fit in the exemplary embodiment.

FIG. 4 shows a chassis containing two half U tray assemblies

FIG. 5A shows two half U tray assemblies mounted in a chassis and swung out to allow access to the interior of a tray assembly.

FIG. 5B shows a detail of the half U tray assemblies mounted in the chassis in a closed position.

FIG. 5C shows a detail of the half U tray assemblies mounted in the chassis in an open position.

### DETAILED DESCRIPTION

The following Detailed Description refers to the accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to effect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only it, accordance with the appended claims and their equivalents.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

According to the present disclosure, assemblies and, methods are provided for facilitating fiber optic patching. More particularly, the disclosed assemblies and methods generally involve mounting fiber optic patch ports arranged along a plane substantially parallel to the base of a tray assembly. The tray assembly is movably positioned within a cabinet enclosure, e.g., via a pivotal or translational (sliding) relationship, thereby providing easy access to the ports. The patch ports may be advantageously aligned at an angle to the front face of the tray to permit the fiber optic cable to be mounted from one side or the other of the tray, rather than being front-loaded, as in standard arrangements. In exemplary embodiments, cable management structures, e.g., fiber management clips, fiber guides, and/or cable management spools, may also be incorporated in order to further promote cable management.

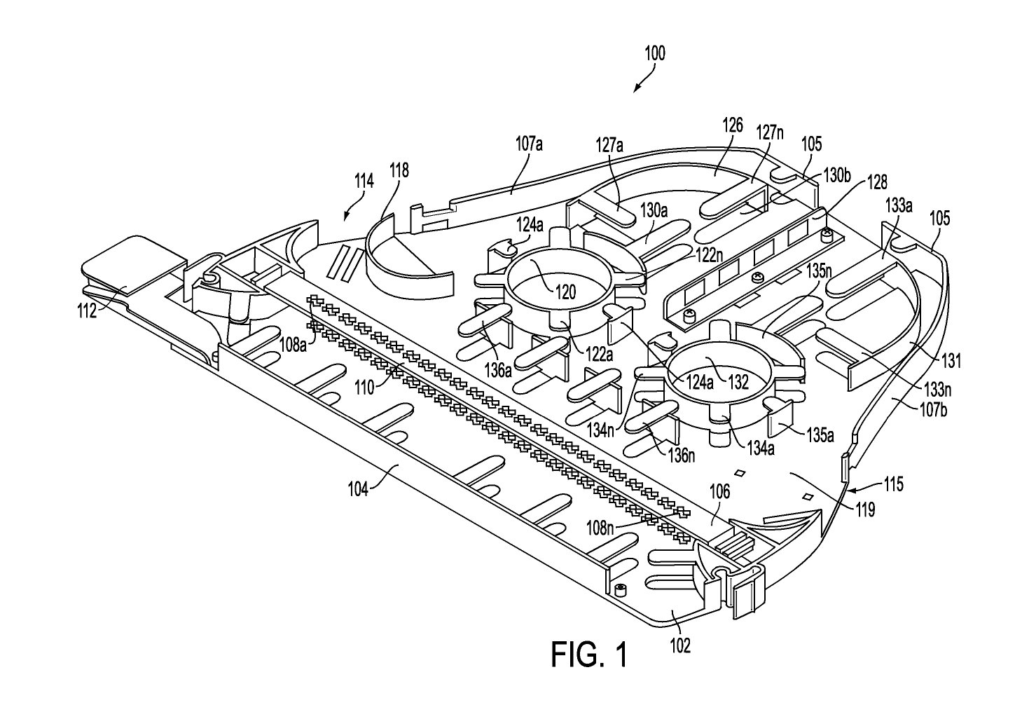

FIG. 1 shows a perspective view of an exemplary fiber optic cable tray assembly 100. Tray assembly 100 comprises a base 102 having a first or front end face or wall 104, a second or rear end face or wall 105 and a pair of side walls 107a, 107b. An adapter clamp 106 is removably mounted to base 102 in a manner to be described in more detail below. Adapter clamp 106 has a plurality of openings 108a . . . n (collectively referred to as openings 108) formed in a substantially planar surface 110 thereof. In one embodiment, openings 108 are substantially X-shaped for reasons to be discussed in more detail below. A fiber manager 112 may be mounted to base 102 on, one side or the other (left or right as shown in FIG. 1) adjacent to front end wall 104. Fiber manager 112 is described in more detail below.

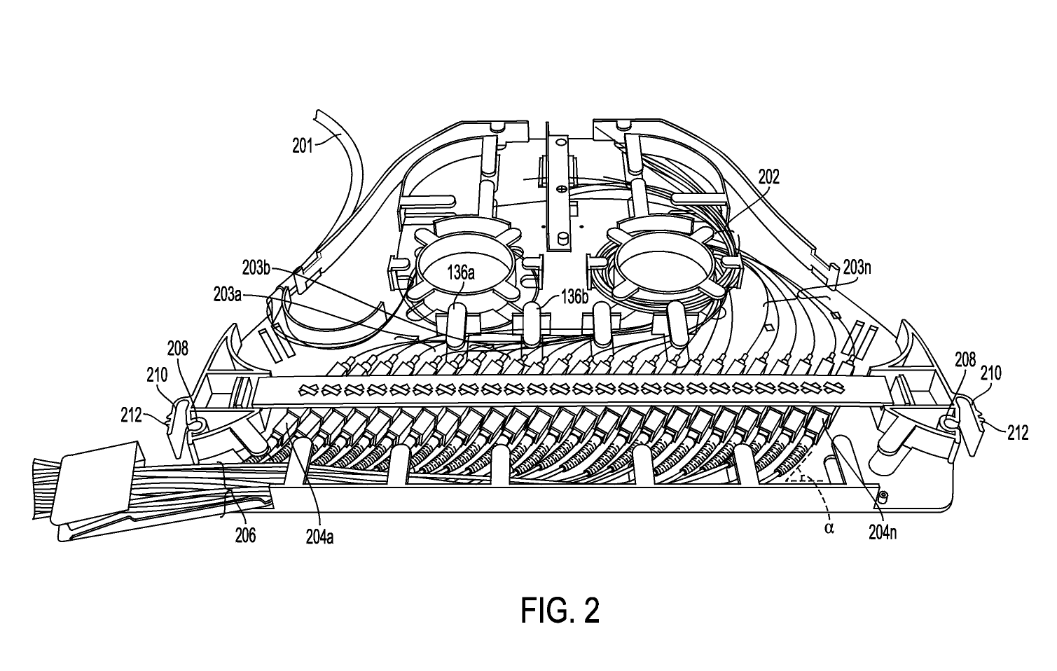

It is important to protect the fiber cables as they are routed within the tray. Base 102 has formed thereon or attached thereto various cable winding features. An input fiber optic cable 201 (see FIG. 2) may enter tray assembly 100 through an opening 114 in side wall 107a of tray assembly 100. Input cable 201 is wound around a substantially half-moon guide 118 mounted to base 102 as it enters tray assembly 100. Guide 118 is removable or it may be selectively mounted on the opposite side of base 102 at location 119 if cable 201 is intended to enter tray assembly 100 from the other side (i.e., right side, not shown) through an opening 115 in side wall 107b. Cable 201 is then wound around a first circular guide 120. Guide 120 has a plurality (generally, but not necessarily, four) of extensions 122a . . . n (collectively referred to as extensions 122) that extend generally radially outwardly from circular guide 120. In addition, a plurality (generally, but not necessarily, three) of fixed guides 124a . . . n (collectively referred to as fixed guides 124) are mounted to base 102 adjacent circular guide 120 to further retain the cable within the bounds of circular guide 120. Extensions 122 and fixed guides 124 help keep cable 201 aligned with circular guide 120.

A curved guide 126 is fixed to base 102 of tray assembly 100 in such a manner as to guide cable 201 toward a splice holder or MPO fiber optic adapter panel 128. Splice holder or MPO fiber optic adapter panel 128 may be generally referred to as an “interconnect panel.” Curved guide 126 includes extensions 127a . . . n (collectively referred to as extensions 127) which aid in guiding cable 201 toward interconnect panel 128 and in retaining the cable within the bounds of curved guide 126. Guide 126 may be secured to base 102 in any manner that would be apparent to one skilled in the relevant art; alternatively, guide 126 may be fixed to base 102 by press fitting guide 126 into openings 130a, 130b formed in base 102.

After looping around cable guides 118, 120, and 126, incoming cable 201 terminates at interconnect panel 128. Interconnect panel 128 can hold multiple cable adapters or splices which split cable 201 into multiple fiber optic leads 202 (see FIG. 2). On the opposite side of base 102 from cable guides 118, 120, and 126 are fiber optic lead guides. The lead guides include a curved lead guide 131. Curved lead guide 131 includes extensions 133a . . . n (collectively referred to as extensions 133). Guide 131 and extensions 133 aid in guiding fiber optic leads 202 away from interconnect panel 128 and in retaining the fiber leads 202 within the bounds of curved guide 131. After exiting guide 131, fiber optic leads 202 are fed around a second circular guide 132. Guide 132 has a plurality (generally, but not necessarily, four) of extensions 134a . . . n (collectively referred to as extensions 134) that extend generally radially outwardly from circular guide 132. In addition, a plurality (generally, but not necessarily, three) of fixed guides 135a . . . n (collectively referred to as fixed guides 135) are mounted to base 102 adjacent circular guide 132 to further retain fiber optic leads 202 within the bounds of second circular guide 132. Extensions 134 and fixed guides 135 help keep fiber optic leads 202 aligned with circular guide 132.

Interconnect panel 128 lies substantially in a plane bisecting base 102 such that the cable guides, for example, guides 118, 120, and 126, lie on one side of interconnect panel 128 and the lead guides, for example, guides 131 and 132 lie on the other side of interconnect panel 128, substantially as shown in the embodiment of FIG. 1. It will be apparent to one skilled in the relevant art that adapter panel 128 need not lie in the plane bisecting base 102 nor is it necessary that the cable guides and lead guides be substantially mirror images of each other.

Fiber optic leads 202 terminate downstream of second circular guide 132 at a plurality of adapters 204a . . . n (collectively referred to as adapters 204). Adapters 204 collectively comprise an adapter pack for securing connections between fibers of optic leads 202 (and fibers of input fiber cable 201) and fibers of output fiber leads 206. Adapters 204 are mounted to respective openings 108 in adapter clamp 106. Adapters 204 may be mounted at an angle a greater than 0° and less than 90° relative to end wall 104 (or a vertical plane defining a side of tray assembly 100, for example, the front, user-accessible side of tray assembly 100 when mounted in a rack) and substantially in the plane of base 102, as shown in FIG. 2.

Adapters 204 may be angled toward the left, as shown in FIG. 2, to permit fiber leads 206 to exit tray assembly 100 toward the left side through fiber manager 112 or to the right (not shown) to permit fiber leads 206 to exit tray assembly 100 toward the right side through fiber manager 112. In either case, fiber leads 206 exit tray assembly downstream of adapters 204. When fiber optic leads 206 are oriented to exit the left side of tray assembly 100, adapters 204 may be mounted to adapter clamp 106 via the slots angled to the left of X-shaped openings 108 in adapter clamp 106 as shown in FIG. 2. When fiber optic leads 206 are oriented to exit the right side of tray assembly 100, adapters 204 may be mounted to adapter clamp 106 via the alternate, slots angled to the right of X-shaped openings 108 in adapter clamp 106, so that adapters 204 face in the opposite direction to that shown in FIG. 2.

A plurality of fiber optic lead guides 136a . . . n (collectively referred to as guides 136) may be fixed to base 102 downstream of circular guide 132. Guides 136 operate to guide groups 203a . . . n (collectively referred to as fiber optic groups 203) of fiber optic leads 202 to respective groups of adapters 204. For example, guide 136a guides a first fiber optic group 203a to respective adapters 204a . . . d; guide 136b guides a second fiber optic group 203b to respective adapters 204e . . . 204h; and so on. A last group 203n of fiber optic leads 202 may lie outside the ambit of guides 136. Group 203n is fed from circular guide 132 directly to their respective adapters 204.

Tray assembly 100 is formed with pivot mechanisms that comprise pinched U-shaped openings 208 on both sides extending therethrough into which hinge pins (discussed in more detail below) can extend. This hinged mounting arrangement allows tray assembly 100 to pivot or swing to the outside of a chassis (discussed in more detail below) from either the left side (clockwise as shown in FIG. 2) or from the right side (counterclockwise as shown in FIG. 2). Hook or J-shaped members 210 are fixed to or formed on side walls 107 of tray assembly 100. J-shaped members 210 have stops 212 formed thereon which mate with corresponding parts of a chassis (discussed in more detail below) to lock tray assembly 100 in either an open position or a closed position.

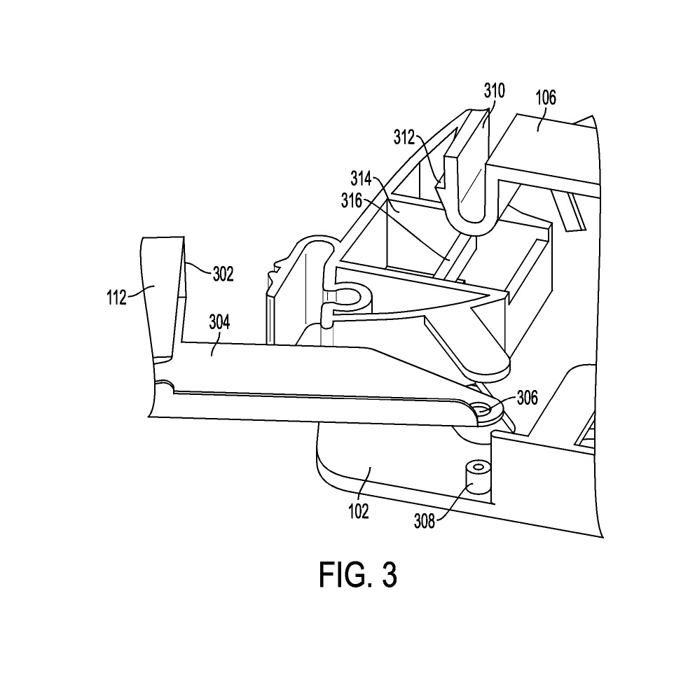

Unlike standard fiber tray assemblies where fibers are brought out of a tray from the front, fibers 206 exit tray assembly 100 from the side through fiber manager 112. Fiber manager 112 comprises a substantially U-shaped portion 302 and an extension 304. Extension 304 Las an opening 306 at one end portion which fits onto a pivot pin 308 extending from base 102. This mounting an arrangement allows fiber manager 112 to pivot about pin 308 while retailing fibers 206 within fiber manager 112. Base 102 may have a pivot pin 308 on both the left side as best seen in FIG. 3 and on the right side as best seen in FIG. 1. This configuration allows fiber manager 112 to be selectively positioned on either the left or right side of tray assembly 100 for left or right side exit, respectively.

In one embodiment, adapter clamp 106 is mounted to tray assembly 100 by a snap fit arrangement. In this embodiment, shown in the drawings, adapter clamp 106 is formed with a resilient, substantially U-shaped portion 310 at each end (only one of which is shown in FIG. 3). The outer side of U-shaped portion 310 has a lip 312. In the embodiment shown in the drawings. base 102 has fixed thereto or formed thereon a housing 314 containing a bar or similar stop member 316 extending at least partially across housing 314. When adapter clamp 106 is mounted to tray assembly 100, the arms of U-shaped portion 310 are pressed together so that U-shaped portion 310 fits into housing 314 until lip 312 lies below stop member 316. Once the clamp is in position, the arms of U-shaped portion 310 are released so that lip 312 engages the underside of stop member 316 to hold clamp 106 in place.

In the embodiment shown in the drawings, cable 201 enters tray assembly 100 through opening 114 in side wall 107a. As will be apparent to those skilled in the relevant art, cable 201 could be fed into tray assembly 100 through corresponding opening 115 in side wall 107b. Half-moon guide 118 can be relocated to corresponding position 119 adjacent side wall 107b to guide cable 201 as it enters tray assembly 100 through the opening in side wall 107b. In that case, the rest of the guides remain unchanged, but fiber optic leads 202 will run through the opposite side of tray assembly 100 from that shown in the drawings via guides 126 and 120.

In the embodiment shown in FIG. 2, adapters 204 are arranged at an angle such that fiber optic leads 206 exit tray assembly 100 from the left side as shown. In the alternate embodiment described above, adapters 204 can be arranged at an opposite angle so that fiber optic leads 206 exit tray assembly 100 from the right side. In that case, fiber manager 112 would be relocated to the right side of tray assembly 100 and be mounted onto a corresponding pivot pin located adjacent the right end of end wall 104 (as best seen in FIG. 1).

In one embodiment, the height of tray assembly 100 is about one half of a rack unit half U—or about 0.875 in. This height is approximately one half the height of a standard tray that holds fiber optic cables, helping to increase rack fiber capacity.

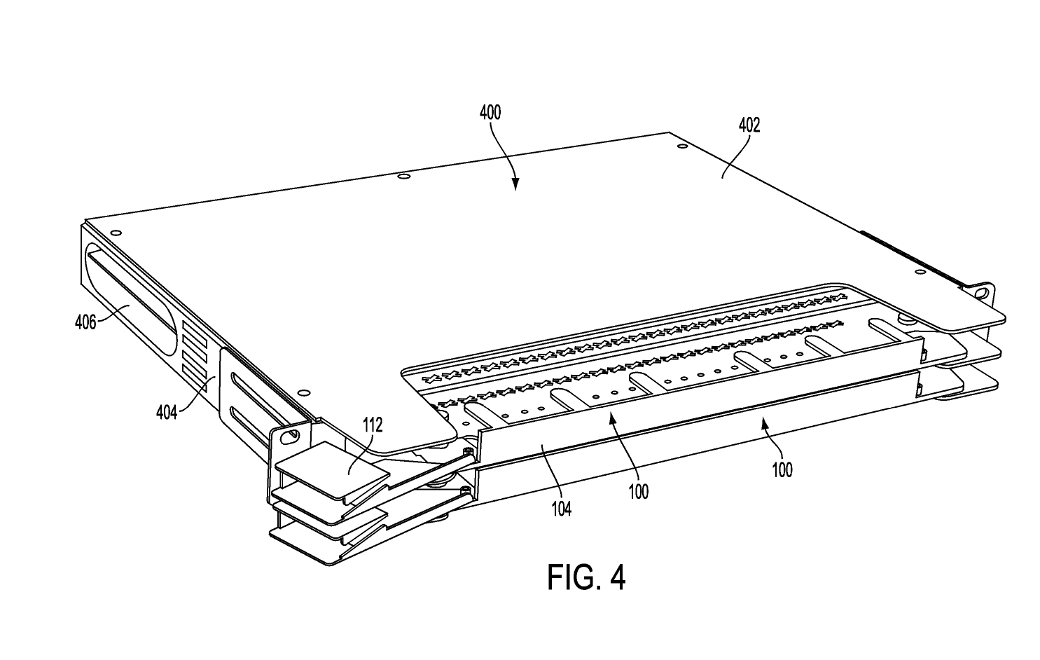

FIG. 4 shows two half U tray assemblies 100 operatively mounted to a one U chassis 400. Chassis 400 has a pair of major (top and bottom) surfaces 402 (only the top surface being, shown) and a pair of minor or side faces 404 (only one of which is shown). Side face 404 has a cable entry opening 406 through which one or more fiber optic cables 201 pass. It will be apparent to one skilled in the relevant art that more than two half U tray assemblies 100 may be mounted, to a chassis 400. In an alternative exemplary embodiment, six half U tray assemblies 100 may be mounted to a three U chassis 400.

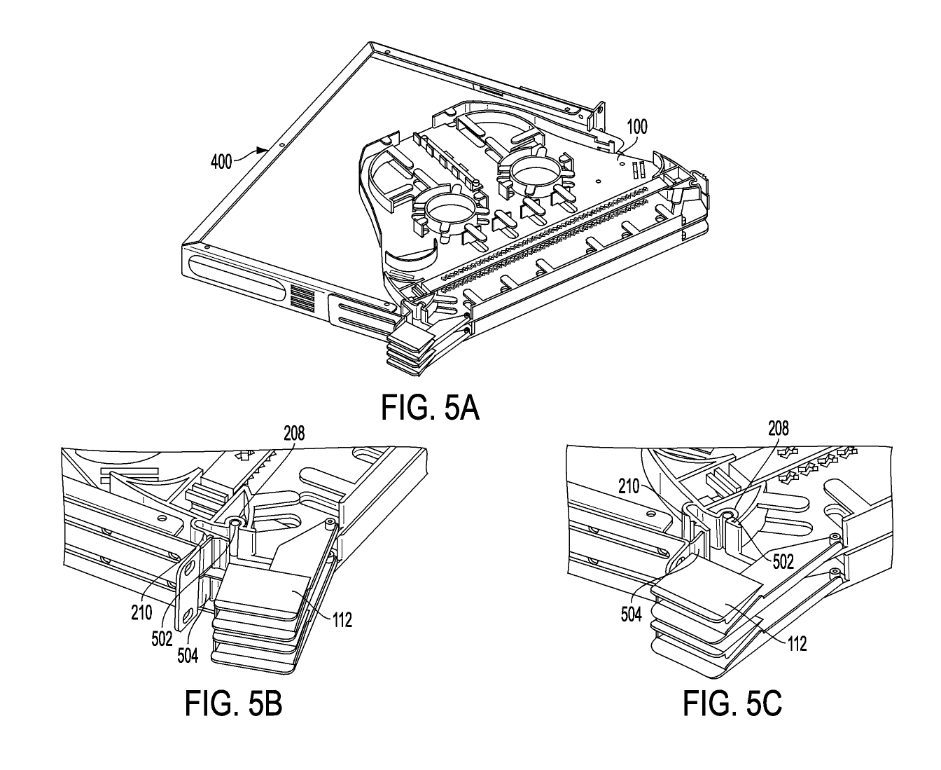

FIGS. 5A-C show various parts of a tray assembly 100 in a swing-out position in chassis 400. FIG. 5A shows a half U tray assembly 100 in an open position relative to chassis 400. FIG. 5B is a detail of the tray locking mechanism in the closed position. A hinge pin 502 is mounted to chassis 400 and extends through pinched U-shaped opening 208. Hinge pin 502 may be mounted to the left side portion or right side portion of chassis 400 so that tray assembly 100 is able to swing to the left (as shown in FIG. 5A) or to the right (not shown). In the closed position of tray assembly 100, stops 212 of J-shaped member 210 engage a plate 504 fixed to chassis 400 in a manner to retain tray assembly 100 in a closed position. FIG. 5C shows a portion of tray assembly 100 in an open position. In this position, stops 212 engage plate 504 in a manner to retain tray assembly in the open position. In the open position, a technician can work on the fiber optic cable in tray assembly 100, as needed or desired.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A fiber optic tray assembly, comprising:
a tray having a base portion configured to hold a fiber optic interconnect or splice;
an adapter clamp configured to be mounted to the tray to secure a fiber optic adapter to the tray at an angle greater then 0° and less than 90° relative to and substantially parallel to the base portion; and
a fiber manager configured to be mounted to one side portion of the tray to secure a fiber optic lead exiting the tray toward the one side portion of the tray.

2. A fiber optic tray assembly according to claim 1, wherein the tray is approximately one half the height of a standard tray that holds fiber optic cables.

3. A fiber optic tray assembly according to claim 1, further comprising:
a fiber manager mounting member disposed on the tray and configured to secure the fiber manager to one side portion of the tray to direct the fiber optic lead to exit the tray toward the one side portion of the tray.

4. A fiber optic tray assembly according to claim 1, further comprising:
fiber manager mounting members disposed on opposite sides of the tray and configured to secure the fiber manager alternatively to opposite sides of the tray as a function of the direction the fiber optic lead is intended to exit the tray.

5. A fiber optic tray assembly according to claim 1, further comprising:
a tray assembly mounting member configured to be disposed on one side of the tray and configured to allow the tray to pivot outwardly of a chassis from one side portion thereof to permit access to the interior of the tray.

6. A fiber optic tray assembly according to claim 1, further comprising:
tray assembly mounting, members configured to be disposed on opposite sides of the tray and configured to allow the tray to pivot alternatively from one side or the other.

7. A fiber optic tray assembly according to claim 1, further comprising:
a fiber optic cable guide fixed to the tray to guide a fiber optic cable within the tray assembly.

8. A fiber optic tray assembly according to claim 7, further comprising:
a plurality of fiber optic cable guides fixed to the tray and configured to guide the fiber optic cable within the tray assembly to an interconnect panel mounted to the tray.

9. A fiber optic tray assembly according to claim 1, further comprising:
a fiber optic lead guide fixed to the tray to guide a fiber optic lead within the tray assembly.

10. A fiber optic tray assembly according to claim 9, further comprising:
an interconnect panel mounted to the tray; and
a plurality of fiber optic lead guides fixed to the tray and configured to guide the fiber optic lead within the tray assembly from the interconnect panel to an adapter secured to the adapter clamp.

11. A fiber optic tray assembly according to claim 9, further comprising:
a securing mechanism configured to secure a pivot member that enables the tray assembly to pivot between open and closed positions.

12. A fiber optic tray assembly according to claim 11, wherein the securing mechanism comprises
a pinched U-shaped opening in a side wall of the tray configured to receive a pivot pin; and
a locking member coupled to the side wall of the tray configured to contact a corresponding locking member in a chassis when the fiber optic tray assembly is mounted to the chassis and lock the tray assembly in either an open or a closed position.

13. A fiber optic tray assembly, comprising:
a tray having a base portion;
a first cable guide mounted to the tray and configured to guide a fiber optic cable within the tray assembly;
a second cable guide mounted to the tray and configured to guide the fiber optic cable from the first cable guide to an interconnect panel mounted to the tray;
a first fiber optic lead guide mounted to the tray and configured to guide a fiber optic lead away from the interconnect, panel;
a second fiber optic lead guide mounted to the tray and configured to guide the fiber optic lead from the first fiber optic lead guide toward an exit region of the tray assembly;
an adapter clamp configured to be mounted to the tray to secure a fiber optic adapter to the tray at an angle greater then 0° and less than 90° relative to and substantially parallel to the base portion; and
a fiber manager configured to be mounted to one side portion of the tray to secure the fiber optic lead exiting the tray downstream of the fiber optic adapter toward the one side portion of the tray.

14. A fiber optic tray assembly according to claim 13, wherein the tray is approximately one half the height of a standard tray that holds fiber optic cables.

15. A fiber optic tray assembly according to claim 13, further comprising:
a fiber manager mounting member disposed on the tray and configured to secure the fiber manager to one side portion of the tray to direct the fiber optic lead to exit the tray toward the one side portion of the tray.

16. A fiber optic tray assembly according to claim 13, further comprising:
fiber manager mounting members disposed on opposite sides of the tray and configured to secure the fiber manager alternatively to opposite sides of the tray as a function of the direction the fiber optic lead is intended to exit the tray.

17. A fiber optic tray assembly according to claim 13, further comprising:
a tray assembly mounting member configured to be disposed on one side of the tray and configured to allow the tray to pivot outwardly of a chassis from one side portion thereof to permit access to the interior of the tray.

18. A fiber optic tray assembly according to claim 13, further comprising:
tray assembly mounting members configured to be disposed on opposite sides of the tray and configured to allow the tray to pivot alternatively from one side or the other.

19. A fiber optic tray assembly according to claim 13, further comprising:
a securing mechanism configured to secure a pivot member that enables the tray assembly to pivot between open and closed positions.

20. A fiber optic tray assembly according to claim 19, wherein the securing, mechanism comprises
a pinched U-shaped opening in a side wall of the tray configured to receive a pivot pin; and
a locking member coupled to the side wall of the tray configured to contact a corresponding locking member in a chassis when the fiber optic tray assembly is mounted to the chassis and lock the tray assembly in either an open or a closed position.
